(19) United States
(12) Patent Application Publication
(10) Pub. No.: US 2026/0368803 A1
(43) Pub. Date: Nov. 19, 2026

(54) System and Method for Real-Time Video-Based Home Service Bidding and Matching

(71) Applicant: Ahmad Alabdallat, Anaheim, CA (US)

(72) Inventor: Ahmad Alabdallat, Anaheim, CA (US)

(21) Appl. No.: 19/211,278

(22) Filed: May 18, 2025

Related U.S. Application Data
(60) Provisional application No. 63/804,953, filed on May 13, 2025.

(51) Int. Cl. G06Q 30/08; H04N 21/2187; H04N 21/234; H04N 21/431; H04N 21/478

(52) U.S. Cl. CPC G06Q 30/08; H04N 21/2187; H04N 21/23418; H04N 21/431; H04N 21/47815

(57) ABSTRACT

A system and method for enabling real-time service provider bidding through a live customer video session. A client device initiates a live video stream of a service-related issue, which is transmitted to a backend server and viewed by multiple service provider devices. An artificial intelligence prompt engine analyzes the live video stream in real time and generates context-specific prompts instructing the customer to reveal additional information relevant to the service request. Service providers submit real-time bids during the live video session based on the video stream and the customer-provided information, allowing the customer to select a service provider efficiently and accurately.

### FIELD OF THE INVENTION

The present invention relates generally to service marketplaces and, more particularly, to a system and method for enabling real-time video-based bidding and matching between customers and service providers.

### BACKGROUND OF THE INVENTION

Conventional service platforms often require customers to upload static photos or text descriptions of their service needs. These limited methods prevent providers from fully assessing the scope of work. As a result, providers may initially give inaccurate estimates based on incomplete information, which can lead to price changes upon arrival. This causes delays, erodes trust, and creates uncomfortable experiences for customers who feel surprised or misled.

In some cases, providers refuse to give any estimate without seeing the issue in person, resulting in further delays of days or more. There is a clear need for a system that enables immediate, accurate quoting while also restoring transparency and trust between service providers and customers.

### SUMMARY OF THE INVENTION

The disclosed invention solves these problems by enabling customers to initiate a live video session showing the service need in real time. Service providers can view the session instantly, assess the issue more accurately, and submit real-time bids. To further improve estimate precision, an integrated AI prompt engine monitors the video stream and suggests specific information the customer may not think to show, such as model numbers, interior parts, or key angles.

For example, if a customer states that a refrigerator is not cooling properly, the AI may prompt: “Please show the model number label inside the fridge.” This suggestion appears on the customer's screen, guiding them in real time. This minimizes unnecessary back-and-forth questions and helps providers give clear, informed estimates during the same session, increasing transparency, trust, and overall service speed.

### BRIEF DESCRIPTION OF THE DRAWINGS

FIG. 1—Customer interface showing “Go Live” button.

FIG. 2—Live customer interface showing repair and incoming bids.

FIG. 3—Provider view showing repair request and open live prompt.

FIG. 4—Provider interface with live video and bid option.

FIG. 5—System process flow for real-time home service bidding.

FIG. 6—Example of AI module generating context-aware prompts during live video session.

### DETAILED DESCRIPTION OF THE INVENTION

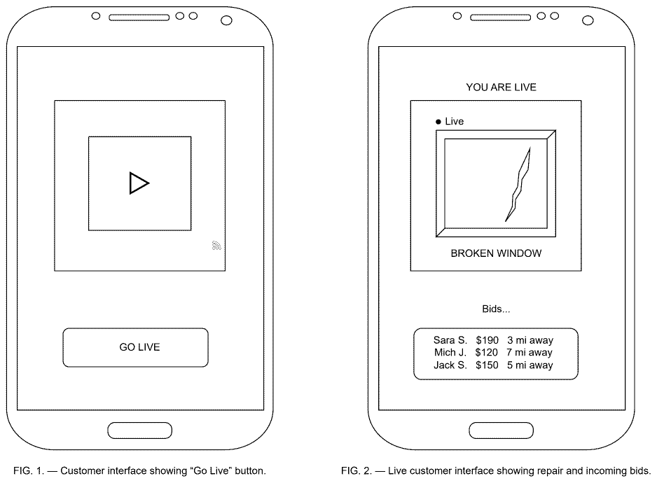

Referring now to FIG. 1, a customer-facing interface is shown with a “Go Live” button, allowing the user to begin a live video session.

FIG. 2 illustrates the live customer session in progress, where incoming bids from service providers are received in real time. This interface allows the customer to compare providers based on bid price and proximity.

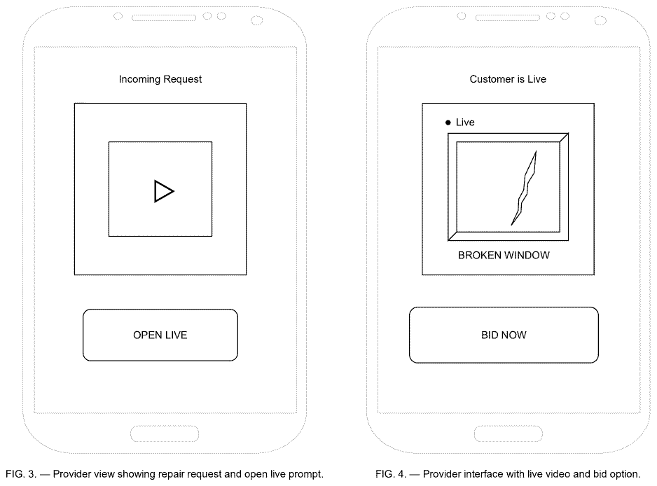

In FIG. 3, the provider interface displays an incoming service request, including a description of the issue and a prompt to join the live session.

FIG. 4 shows the provider's interface once inside the live session, featuring the video stream and the ability to submit a bid.

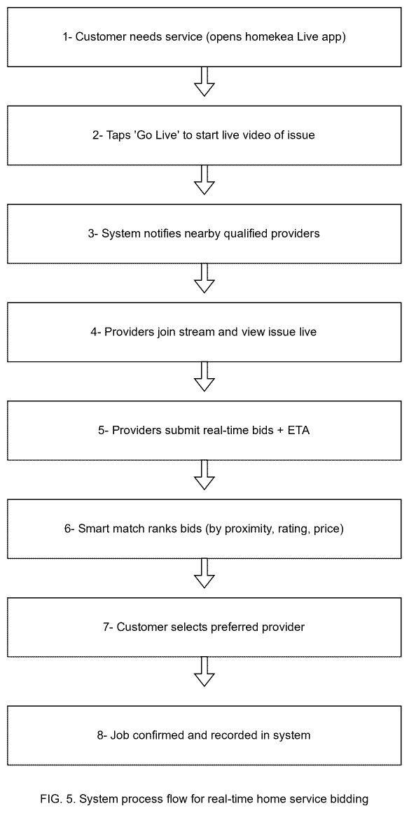

FIG. 5 demonstrates the complete system process: the customer initiates a session, nearby providers are notified, they join the live stream, view the issue, submit bids, and the system ranks those bids for customer selection.

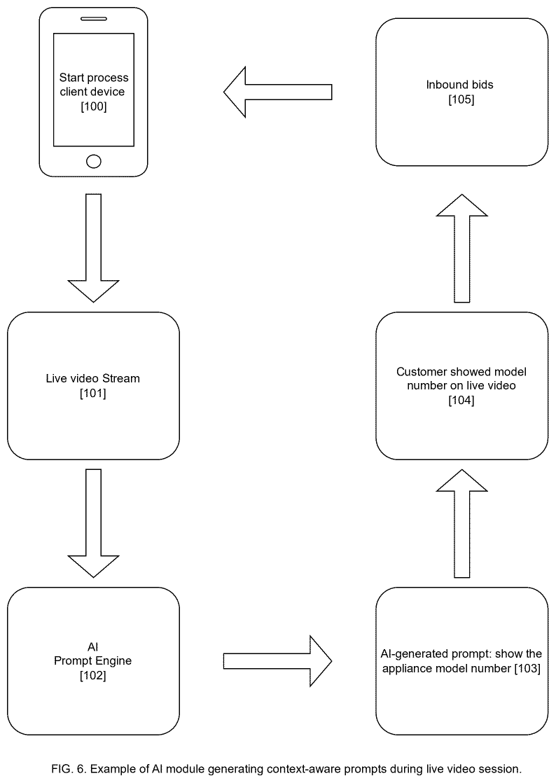

FIG. 6 illustrates a system architecture in which the client device [100] initiates a live video stream [101]. The AI prompt engine [102] analyzes the video and generates a prompt [103], such as “Please show the appliance model number.” The customer responds by showing the requested detail on video [104], and inbound bids [105] are generated based on the visual information provided during the live session.

1. A system for enabling real-time service provider bidding during a live customer video session, comprising:
a client device configured to initiate a live video stream capturing a service-related issue;
a backend server configured to receive the live video stream from the client device;
a plurality of service provider devices configured to view the live video stream in real time;
an artificial intelligence prompt engine configured to analyze the live video stream and generate context-specific prompts during the session;
a prompt displayed on the client device instructing the customer to provide additional information relevant to the service request; and
a bidding interface through which one or more service provider devices submit real-time bids based on the live video stream and the customer-provided information.

2. The system of claim 1, wherein the context-specific prompts include instructions to display model numbers, serial labels, or internal components not initially visible in the live video stream.

3. The system of claim 1, wherein the artificial intelligence prompt engine utilizes image recognition to identify an appliance type or repair category based on visual data from the live video stream.

4. The system of claim 1, wherein the artificial intelligence prompt engine dynamically updates prompts in response to incoming visual data during the live video session.

5. The system of claim 1, wherein the bidding interface displays bid price, service provider location, and estimated arrival time in real time.

6. The system of claim 1, further comprising a transaction module configured to confirm bid acceptance by the customer and notify a selected service provider.
